(19) United States
(12) Patent Application Publication
(10) Pub. No.: US 2005/0137838 A1
(43) Pub. Date: Jun. 23, 2005

(54) Dial-up resource simulator

(76) Inventor: Dayne H. Medlyn, Windsor, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/737,838

(22) Filed: Dec. 18, 2003

(51) Int. Cl. G06F 17/50

(52) U.S. Cl. 703/13

(57) ABSTRACT

An apparatus to enable an application which tests a data service, including a dial-up resource simulator to simulate a dial-up resource to connect the application and the data service.

### BACKGROUND OF THE INVENTION

1. Field of the Invention

The present invention relates to a dial-up resource simulator used to enable a test application which tests a data service.

2. Description of the Related Art

Providers of data services, such as email, MMS, SMS or even digital cellular or dial-up service providers must test their services to ensure quality. This testing may be achieved by running a test application, which may be developed by and purchased from another party. While developing the test application, the test application must be run over the network for which it is intended to be used.

FIG. 1 is a block diagram of a conventional system 100 to enable a test application 112. A computer 110 runs the test application 112. The test application 112 is connected to a digital cell phone 120, which connects the test application 112 to a wireless receiver 130 which connects with a data service 140 via a network 135.

As illustrated in FIG. 1, the system 100 includes a network 135 between the wireless receiver 130 and the data service 140. The network 135 may be an IP network layered on top of a carrier network or a non-IP digital wireless carrier network.

As illustrated in FIG. 1, the system 100 includes a wireless connection between the test application 112 and the data service 140. Although not illustrated, a wired connection is also possible in which the digital cell phone 120 and wireless receiver 130 are replaced with modems which connect via a conventional telephone line.

FIG. 2 is a flow diagram of a method of enabling the test application 112 of FIG. 1. First, a connection is established between the test application 112 and the modem (wired) or digital cell phone 120 (wireless) (S100).

Next, in the case of an IP based connection, a connection is established between the test application 112 and the data service 140 (S110a). This connection may be a GPRS network, when making an IP connection over a wireless link, or a standard modem connection on a switched phone network, when making an IP connection over a wired link. In either case, the connection is typically achieved via Point to Point Protocol (PPP). Alternately, in the case of a non-IP based connection, the test application 112 interacts with a digital cellular data service (S110b). This digital cellular data service is provided by the digital wireless carrier network (such as a GSM, CDMA, or TDMA network), without requiring an IP network. Next, the test application 112 exercises the data service 140 (S120).

The conventional approach has the following disadvantages. In the case of testing wireless services, there are acute dependencies on the existence of a wireless network. A wireless network for services testing is expensive to deploy and maintain. Use of existing services through commercial service providers is also expensive and limited by non-deterministic behavior. Also, wireless and wired services may not be readily available for development and testing. For example, some services (such as GPRS) may only be available in European geographies while development is done in the United States, requiring troublesome development and testing on remote systems with limited physical contact to the systems. In the past, testing of wireless services has required the purchase of mobile devices and SIM cards for those devices. Testing has been done by locating hardware in geographies with the wireless services and managing those devices remotely.

### SUMMARY OF THE INVENTION

Accordingly, selected embodiments of the present invention overcome the above disadvantages of the conventional system.

The present invention could possibly provide an apparatus to reduce costs when evaluating an application which tests a data service over a dial-up connection.

The present invention also could possibly provide a simulator to simulate various dial-up devices.

Additional aspects and advantages of the invention will be set forth in part in the description which follows and, in part, will be obvious from the description, or may be learned by practice of the invention.

The foregoing and other advantages may be achieved by providing an apparatus to enable an application which tests a data service, including a dial-up resource simulator to simulate a dial-up resource to connect the application and the data service.

The foregoing and other advantages may also be achieved by providing a method of enabling an application which tests a data service, including simulating a dial-up resource to connect the application and the data service with a simulator.

The foregoing and other advantages may also be achieved by providing a system including a test application to test a data service, and a simulator to simulate a dial-up resource to connect the test application and the data service.

### BRIEF DESCRIPTION OF THE DRAWINGS

These and other aspects and advantages of the invention will become apparent and more readily appreciated from the following description of the preferred embodiments, taken in conjunction with the accompanying drawings of which:

FIG. 1 is a block diagram of a conventional system to enable a data service test application;

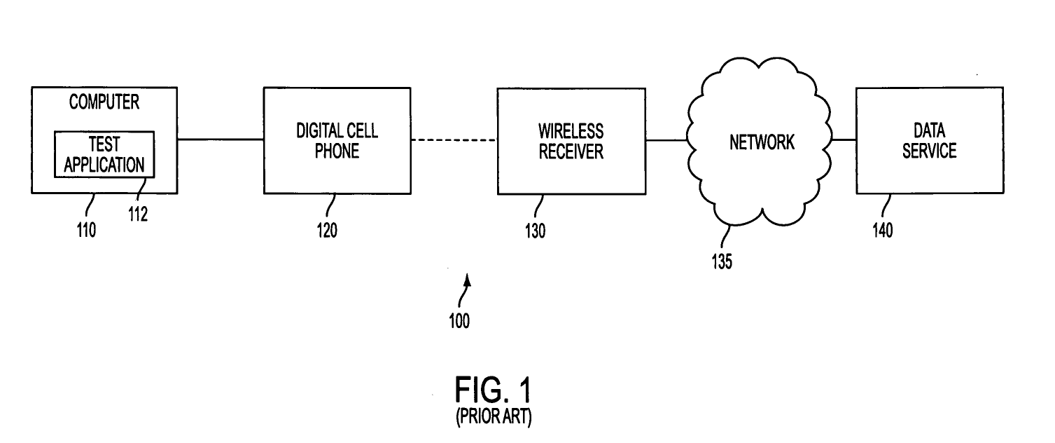

FIG. 2 is a flow diagram of a conventional method of enabling the data service test application of FIG. 1;

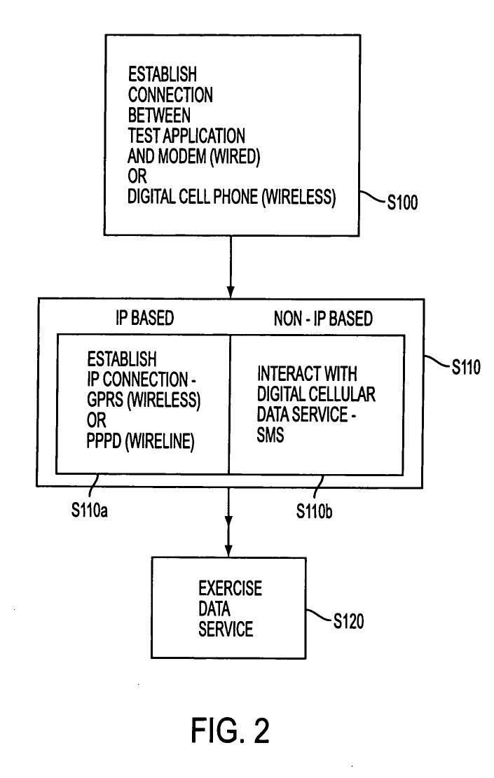

FIG. 3. is a block diagram of a system to enable a data service test application according to embodiments of the present invention; and

FIG. 4 is a flow diagram of a method of enabling the data service test application of FIG. 4.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

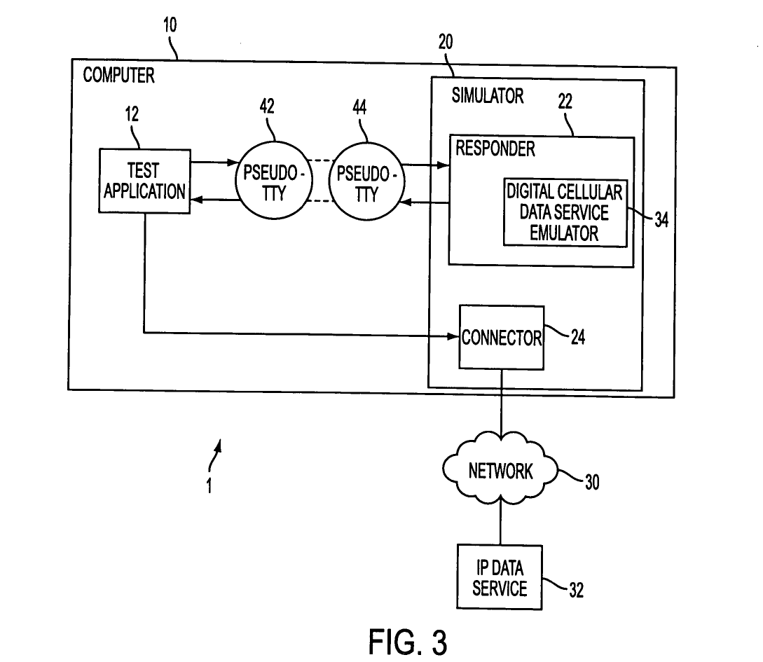

FIG. 3 is a block diagram of a system 1 to enable a data service test application 12 according to the embodiments of the present invention. As illustrated, the test application 12 is a computer program, run by a computer 10. The test application 12 is connected to a dial-up resource simulator 20. The simulator 20 simulates the function of a dial-up resource such as a digital cell phone, an AT modem, or any device that utilizes modem style AT commands which connects the test application 12 to a data service 32 or a digital cellular data service emulator 34 (described below). A dial-up resource is any type of device, supporting an AT-style command set, which interfaces a computer with an on-demand switched network (either wired or wireless). The interface is achieved via the use of AT commands, which are commands, typically beginning with “AT”, to control a dial-up resource by querying and setting registers internal to the dial-up resource. The simulator 20 includes a responder 22, a connector 24. The responder 22 includes a digital cellular data service emulator 34. The responder 22 may be the AT-command simulator, or any other device that can receive register initialization and query commands (such as AT commands) from the test application 12 and simulate the response of a dial-up resource to the commands.

Pseudo-TTY units 42, 44 connect the test application 12 with the responder 22. The pseudo-TTY units 42, 44 may be a software serial device such as Unix-style ptty devices, or any other software serial device that can receive and transmit serial data.

The digital cellular data service emulator 34 may be a program, or any device that emulates a digital cellular data service, such as SMS, that is controlled through AT-style commands. Digital cellular data services are defined as services provided by a digital cellular service provider that are internal to the digital cellular network, and not IP connection based,

The connector 24 establishes a connection to an IP network 30 which then connects to an IP data service 32. The connector 24 may be a known device such as the pppd simulator, or any other utility that can establish an IP network connection between the test application 12 and the data service 32.

This simulated connection may be achieved, for example, if the connector 24 is a pppd wrapper. A pppd wrapper gives the appearance of the pppd utility to the test application 12 to thereby establish an IP network connection to connect the test application 12 with the network 30 and simulate the function of an AT modem or other dial-up resource. The utility pppd is a known utility for establishing a network connection via a dial-up resource. The present invention is not limited to wrapping pppd, but may also simulate other utilities, such as SLIP or other serial line internet protocol utilities.

The listed examples with respect to the responder 22, the connector 24 and the pseudo-TTY units 42, 44 are not limiting, and any apparatus to achieve the above-described functions of these elements may be used.

The data service 32 may be, for example, an HTTP service, a mail service, a news service, or an MMS (Multimedia Message Service) service. The digital cellular data service emulator 34 may be a modeling program of the actual service, SMS (Short Message Service) service for example. However, these are only examples, and any service which provides access to, transmission of, or searching of data is possible.

The simulator 20 may simulate the function of any AT-style modem or dial-up resource, thereby simulating either wired or wireless connections. Specifically, the connection via the network 30 simulates either a wired or a wireless connection and the connection between the connector 24 and the digital data service 34 simulates purely a wireless connection on the digital wireless carrier network. The network 30 may be a local area network (LAN), the Internet, or any global communications network. Although the concept of a “simulator” is well known, the application of this concept to simulate a dial-up resource as described herein is not.

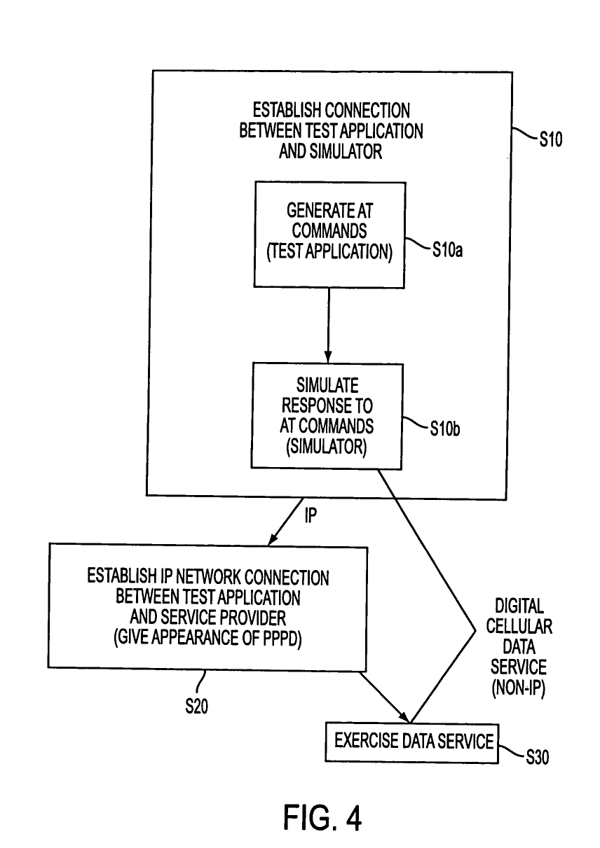

FIG. 4 is a flow diagram of a method of enabling the data service test application 12 of FIG. 3. First, a connection is established between the test application 12 and the dial-up resource simulator 20 (S10). The operation S10 includes two sub-operations. First, the test application 12 generates AT commands so that the test application 12 may initialize a dial-up resource, establish and authenticate the provider of the dial-up services, and authenticate the identity of the user of the test application 12 (S10A). Then, the responder 22 simulates the response of an actual dial-up resource to the AT commands and sends this response back to the test application 12 via the pseudo-TTY units 42, 44. The response may be either static or dynamic.

Next, in the case of an IP connection, a network connection is established between the test application 12 and the data service 32 or the emulator 34 (S20). This is achieved by giving the appearance that pppd is run. Unlike an actual pppd connection, local networks may be used in the present embodiments. The network connection may be, for example, an IP connection or any simulated cellular data network connection. These are just examples, however, any type of connection is possible.

In the case of a non-IP connection, operation S20 is not necessary.

Next, the test application 12 exercises the data service 32 or the emulator 34 (S30). This exercising may be, for example, testing how long it takes to post or receive a SMS message, create or receive an MMS message, pull email from an email server or determine whether the appropriate content is provided.

The discussion of FIG. 4 has shown illustrative examples, however, the present invention is not limited to these examples. For example, the connection between the test application 12 and the simulator 20 may be achieved by any command system that permits querying and setting state registers of a dial-up resource to establish an IP network. Instead of giving the appearance of pppd in operation S20, the connector 24 may give the appearance of establishing a SLIP connection. Numerous ways of exercising the data service other than those listed are also possible.

By enabling the test application 12 according to these embodiments, it is also possible to evaluate the test application 12 itself.

The present embodiments have the following advantages. First, the dial-up resource simulator minimizes the dependency on a dial-up, such as wireless, network, making it possible to do local testing with less expensive hardware than the needs of a dial-up network. Also, the dial-up resource simulator minimizes the amount of development and testing on expensive, remotely located hardware and the additional costs of purchasing dial-up services. The dial-up resource simulator also enables the emulation of large numbers of devices that would otherwise be economically infeasible.

Although embodiments of the present invention have been shown and described, it will be appreciated by those skilled in the art that changes may be made in these embodiments without departing from the principles and spirit of the invention, the scope of which is defined in the claims and their equivalents.

1. An apparatus to enable an application which tests a data service, the apparatus comprising:
a dial up resource simulator to simulate a dial-up resource to connect the application and the data service.

2. The apparatus of claim 1, wherein the simulator simulates a mobile phone service.

3. The apparatus of claim 1, wherein the simulator simulates an AT-modem.

4. The apparatus of claim 1, wherein the simulator comprises a responder to simulate a response to an AT command received from the application to thereby establish a connection between the simulator and the application.

5. The apparatus of claim 1, wherein the simulator comprises a connector to give an appearance of pppd to the application to connect the application to the data service over a network.

6. The apparatus of claim 5, wherein the network is a LAN.

7. The apparatus of claim 5, wherein the connector is a pppd wrapper.

8. The apparatus of claim 4, wherein the responder comprises:
an emulator to emulate a digital cellular data service.

9. The apparatus of claim 8, further comprising:
a first pseudo-TTY unit to receive the AT command from the application and receive the response from the simulator; and
a second pseudo-TTY unit to transmit the received AT command from the first pseudo-TTY unit to the simulator, and transmit the response from the simulator to the first pseudo-TTY unit.

10. The apparatus of claim 1, wherein the data service is an HTTP service, a mail service, news service, an MMS service, or an SMS service.

11. A method of enabling an application which tests a data service, comprising:
simulating a dial-up resource to connect the application and the data service with a simulator.

12. The method of claim 11, wherein the simulating of the dial-up resource comprises:
establishing a connection between the application and the simulator, comprising:
generating an AT command with the application; and
simulating a response to the AT command by the dial-up resource with the simulator.

13. The method of claim 11, wherein the simulating of the dial-up resource comprises:
establishing a network connection between the application and the data service, comprising simulating a pppd, comprising establishing an IP connection over a LAN.

14. The method of claim 13, wherein the establishing of the network connection comprises emulating the data service.

15. The method of claim 11, further comprising:
exercising the data service with the application.

16. The method of claim 12, further comprising:
transmitting the AT command from the application to the simulator using a pseudo TTY; and
transmitting the response from the simulator to the application using the pseudo TTY.

17. A system, comprising:
a test application to test a data service; and
a simulator to simulate a dial-up resource to connect the test application and the data service.

18. The system of claim 17, wherein the simulator comprises:
an AT command emulator to emulate a response to an AT command received from the test application.

19. The system of claim 17, wherein the simulator comprises:
a connector to give an appearance of pppd to the test application to connect the test application to the data service over a network.

20. The system of claim 19, wherein the simulator simulates an AT modem which makes a simulated wireless or wired connection with the data service to make a wireless or a wired connection.
